(19) United States
(12) Patent Application Publication
(10) Pub. No.: US 2013/0112679 A1
(43) Pub. Date: May 9, 2013

(54) VEHICULAR REARVIEW ASSEMBLY WITH INDICIA

(71) Applicant: Gentex Corporation, Zeeland, MI (US)

(72) Inventors: Matthew G. Van Wyhe, Grandville, MI (US); David J. Cammenga, Zeeland, MI (US); Joseph P. Brigham, Saugatuck, MI (US); Juan C. Lara, Holland, MI (US)

(73) Assignee: GENTEX CORPORATION, Zeeland, MI (US)

(21) Appl. No.: 13/669,533

(22) Filed: Nov. 6, 2012

Related U.S. Application Data
(60) Provisional application No. 61/556,253, filed on Nov. 6, 2011.

(51) Int. Cl. H05B 1/00

(52) U.S. Cl. 219/202

(57) ABSTRACT

A heating element for use with a mirror element is provided that includes a heating-element substrate, electrical terminals on the substrate configured to receive electrical power from a power source, and at least one heating zone defined by an electrically-conductive trace disposed on the spatially-continuous heating-element substrate in electrical connection with the electrical terminals, wherein an indicia portion of at least one heating zone includes a diagram represented by the electrically-conductive trace.

### CROSS-REFERENCE TO RELATED APPLICATION

This application claims the benefit of and priority to U.S. Provisional Patent Application No. 61/556,253, filed on Nov. 6, 2011, entitled “VEHICULAR REARVIEW ASSEMBLY WITH INDICIA,” the disclosure of which is hereby incorporated herein by reference in its entirety.

### TECHNICAL FIELD

The present invention relates to distinguishing markings and signs used for indication of functional capabilities and operations of vehicular rearview assemblies and rearview assemblies containing such markings and signs and user interface(s) adapted to activate corresponding functional operations.

### BACKGROUND ART

A mirror element used in vehicular rearview assembly and/or assembly itself often employs an operator interface or a user interface (UI) configured to activate an operation of one or more auxiliary devices associated with the rearview assembly. For example, a UI at the front of the assembly may include at least one button (whether actual or virtual) or switch activating at least one of an illumination system, a digital voice processing system, a power supply, a global positioning system, a light control, a sensor (such as, for example, a moisture sensor, a light sensor, an approach warning, a lane departure warning sensor system), an indicator (such as, for example, a blind spot indicator, a temperature indicator, or a turning signal indicator), a compass, a voice activated device, a microphone, an electronic circuitry (such as an auto-dimming circuitry of an EC-element based mirror), a telecommunication system, a navigation aid, an adaptive cruise control, a vision system (for example, a rear vision system), a tunnel detection system, and a heater associated with the rearview assembly. Such button or switch quite often require an icon or graphical and/or textual indicia observable by a user and indicating which device and/or function of the rearview assembly this button or switch are intended to (de)activate. Icons or indicia, in turn, are often structured to be backlit such that the user, upon providing his input to the UI, becomes aware of the activation of a corresponding device or function of the rearview assembly by observing the highlighted or lit indicia. Formation and alignment of indicia and icons in cooperation with the mirror element of the rearview assembly remains subject of continuing development.

### SUMMARY OF THE INVENTION

According to one aspect of the present invention, a heating element for use with a mirror element includes a heating-element substrate, electrical terminals on the substrate configured to receive electrical power from a power source, and at least one heating zone defined by an electrically-conductive trace disposed on the spatially-continuous heating-element substrate in electrical connection with the electrical terminals, wherein an indicia portion of at least one heating zone includes a diagram represented by the electrically-conductive trace.

According to another aspect of the present invention, a vehicular rearview mirror assembly includes an electrochromic (EC) element having a first glass element having a front surface and a back surface, a second glass element having a front surface and a back surface, a reflective coating having a transflective zone on a surface internal to the EC element, wherein the mirror assembly further includes a substantially opaque layer affixed to the back surface of the EC element, the substantially opaque layer having at least one opening therethrough defined by an opening boundary, and at least one heating zone defined by an electrically-conductive trace disposed on the spatially-continuous heating-element substrate in electrical connection with the electrical terminals, wherein an indicia portion of at least one heating zone includes a diagram represented by the electrically-conductive trace.

According to yet another aspect of the present invention, a rearview mirror element includes a reflective coating having a transflective zone on a surface internal to the EC element, and a substantially opaque layer affixed to the back surface of the EC element, said substantially opaque layer having at least one laser ablated opening therethrough defined by an opening boundary, wherein a back surface of the rearview mirror element within the bounds of said laser ablated opening is roughed.

### BRIEF DESCRIPTION OF THE DRAWINGS

The invention will be more fully understood by referring to the following Detailed Description in conjunction with the Drawings, of which:

FIG. 1A is a cross-sectional view of a portion of an embodiment of a rearview assembly.

FIG. 1B is a cross-sectional view showing a bigger portion of the embodiment of FIG. 1A.

FIG. 2 is a cross-sectional view of a mirror element, for use with a rearview assembly, according to an embodiment of the invention.

FIGS. 3A and 3B are cross-sectional views of alternative embodiments of the invention.

FIGS. 4 and 5 are cross-sectional views of alternative embodiments that include a rounded peripheral edge of the first substrate of the mirror element.

FIG. 6 is a schematic front view of embodiments of FIGS. 4 and 5.

FIG. 7 is a cross-sectional view of an embodiment of a mirror element having a transflective zone formed by a spatially-patterned reflecting layer.

FIG. 8 is a pattern of electrically-conductive traces of a conventional heating element.

FIG. 9A is a pattern of electrically-conductive traces of a heating element according to an embodiment of the invention.

FIG. 9B is an alternative pattern of electrically-conductive traces of a heating element according to an embodiment of the invention.

FIG. 9C is an alternative pattern of electrically-conductive traces of a heating element according to an embodiment of the invention.

FIG. 10 is a cross-sectional view of a mirror element that includes an icon area formed by traces of a heating element according to an embodiment of the invention.

FIGS. 11A, 11B are front views corresponding to the embodiment of FIG. 10.

FIG. 12 is an alternative embodiment including an icon area formed traces of a heating element.

FIG. 13 is a cross-sectional view of a mirror element having an icon area configured in a heating element.

FIG. 14 is a cross-sectional view of another embodiment of the invention.

### DETAILED DESCRIPTION

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In addition, the following disclosure may describe features of the invention with reference to corresponding drawings, in which like numbers represent the same or similar elements wherever possible. In the drawings, the depicted structural elements are generally not to scale, and certain components are enlarged relative to the other components for purposes of emphasis and understanding. It is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed. Furthermore, the described single features, structures, or characteristics of the invention may be combined in any suitable manner in one or more further embodiments.

For example, to simplify a particular drawing of an electro-optical device of the invention not all thin-film coatings (whether electrically conductive, reflective, or absorptive or other functional coatings such as alignment coatings or passivation coatings), electrical interconnections between or among various elements or coating layers, elements of structural support (such as holders, clips, supporting plates, or elements of housing, for example), or auxiliary devices (such as sensors, for example) may be depicted in a single drawing. It is understood, however, that practical implementations of discussed embodiments may contain some or all of these features and, therefore, such coatings, interconnections, structural support elements, or auxiliary devices are implied in a particular drawing, unless stated otherwise, as they may be required for proper operation of the particular embodiment.

The invention as recited in claims appended to this disclosure is intended to be assessed in light of the disclosure as a whole.

Embodiments of the present invention may be used with various types of automotive rearview assemblies that include, without limitation, a rearview assembly incorporating transflective elements (i.e. elements that are partially transmissive and partially reflective), a rearview assembly including prismatic reflective elements, a rearview assembly incorporating an electrochromic mirror element, and a rearview assembly incorporating an auxiliary device such as, for example, display, an illumination system, a digital voice processing system, a power supply, a global positioning system, a light control, a sensor (such as, for example, a moisture sensor, a light sensor, an approach warning, a lane departure warning sensor system), an indicator (such as, for example, a blind spot indicator, a temperature indicator, or a turning signal indicator), a compass, a voice activated device, a microphone, an electronic circuitry (such as an auto-dimming circuitry of an EC-element based mirror, or a controller), a telecommunication system, a navigation aid, an adaptive cruise control, a vision system (for example, a rear vision system), a tunnel detection system, and a heater. Transflective optics of the mirror assembly may be, without limitation, partially transmissive, directionally transmissive, multichroic, or polarization-sensitive. Various rearview and sideview mirror structures and related methods of fabrication have been addressed, for example, in U.S. Pat. Nos. 5,818,625; 6,166,848; 6,356,376; 6,700,692; 7,009,751; 7,042,616; 7,221,363; 7,372,611; 7,502,156; U.S. Patent Publications Nos. 2006/0007550, 2008/0068520, 2008/0030836, 2008/0302657, 2008/0310005, and 2007/0201122, 2009/0296190, 2010/0277786; and the international patent application PCT/US2011/043191 filed on Jul. 7, 2011. The rearview and sideview mirror assemblies may comprise surfaces of various geometries such as, by way of non-limiting example, planar, cylindrical, convex, aspheric, prismatic, other complex surfaces, or combinations thereof such as, for example, a mirror geometry described in U.S. patent application Ser. No. 13/279,256 filed on Oct. 22, 2011. Applications illustrating various types of automotive mirror displays are disclosed, for example, in commonly assigned U.S. Pat. Nos. 6,870,655; 6,737,630; 6,572,233; 6,552,326; 6,420,800; 6,407,468; 6,346,698; 6,170,956; 5,883,605; and 5,825,527, U.S. patent application Ser. No. 12/367,143 titled “A Vehicular Rearview Mirror Assembly Including Integrated Backlighting for a Liquid Crystal Display (LCD)”; Ser. No. 12/193,426 titled “Vehicle Rearview Assembly Including A Display for Displaying Video Captured by a Camera and User Instructions”; Ser. No. 12/196,476 titled “Discrete LED Backlight Control for a Reduced Power LCD Display System”; and Ser. No. 12/964,521 titled “Modular Display for Back-up Camera in Automotive Interior Mirror.” Various types of displays incorporated within the rearview automotive mirror are known in the art such as alphanumeric displays, graphical displays, video displays such as rear camera display (RCD), and combinations thereof. These displays are discussed, for example, in U.S. Pat. No. 7,221,363, and in U.S. Patent Publication No. 2008/0068520. Discussion related to heating elements of a rearview assembly is provided, for example, in U.S. patent application Ser. No. 12/686,019 titled “Heaters for Auto Mirrors and Rearview Assemblies Using the Same”. These documents are collectively referred to herein as “Our Prior Applications.” Each of these documents if incorporated herein by reference in its entirety.

As broadly used and described herein, the reference to a layer (such as an electrically-conductive layer, or a dielectric thin-film layer, for example) as being “carried” on a surface of an element refers to a that is disposed either directly on the surface of an element or on another coating, layer or layers that are, in turn disposed directly on the surface of the element.

Numbering of structural surfaces. In describing the order of elements or components in embodiments of a vehicular rearview assembly or a sub-set of a vehicular rearview assembly, the following convention will be generally followed herein, unless stated otherwise. The order in which the surfaces of sequentially positioned structural elements of the assembly (such as substrates made of glass or other translucent material) are viewed is the order in which these surfaces are referred to as the first surface (or surface I), the second surface (or surface II), the third surface (or surface III), and other surfaces (IV, V and so on), if present, are referred to in ascending order. Generally, therefore, surfaces of the structural elements (such as substrates) of an embodiment of the invention are numerically labeled starting with a surface that corresponds to the front portion of a rearview assembly and that is proximal to the observer or user of the assembly and ending with a surface that corresponds to the back portion of an assembly and that is distal to the user. Accordingly, the term “behind” refers to a position, in space, following something else and suggests that one element or thing is at the back of another as viewed from the front of the rearview assembly. Similarly, the term “in front of refers to a forward place or position, with respect to a particular element as viewed from the front of the assembly.

European regulations of automotive design require that a non-recessed hard edge of any element be rounded, as a safety measure, with a radius of at least 2.5 mm. (See, in particular, the U.N. Economic Commission for Europe Vehicle Regulation No. 46, commonly referred to as ECE Reg. 46). In response to such a requirement, a non-recessed perimeter edge of an automotive rearview assembly may be covered with an appropriate bezel having a lip extending over the perimeter edge of the mirror element with an outer radius of at least 2.5 mm. For aesthetic reasons it is often desirable to either not have a perimeter bezel or have a structural portion that does not extend over the front surface of the mirror but surrounds the perimeter edge of the mirror element around its perimeter and, optionally, is substantially leveled with the front mirror element. In this case, it is either the front substrate itself or a structural portion surrounding the perimeter edge of the front substrate that has an outer-perimeter edge rounded with an at least 2.5 mm radius. Further in this discloser, such rounding of the hard edge is indicated with and referred to as Rad.

The spectrum of light reflected (and that of light transmitted) by an embodiment of the mirror system of the invention can be tuned or modified by adjusting the thickness of the reflectance-enhancing layers. The peak reflectance will vary with optical design wavelength and this will result in a change in color gamut of the reflected (and transmitted) light. In discussing color distributions (i.e., spectra of light), it is useful to refer to the Commission Internationale de I'Eclairage's (CIE) 1976 CIELAB Chromaticity Diagram (commonly referred to the L*a*b* chart or quantification scheme). The technology of color is relatively complex, but a fairly comprehensive discussion is given by F. W. Billmeyer and M. Saltzman in Principles of Color Technology, 2^{nd} Edition, J. Wiley and Sons Inc. (1981). The present disclosure, as it relates to color technology and uses appropriate terminology, generally follows that discussion. As used in this application, Y (sometimes also referred to as Cap Y), represents either the overall reflectance or the overall transmittance, depending on context. L*, a*, and b* can be used to characterize parameters of light in either transmission or reflection. According to the L*a*b* quantification scheme, L* represents brightness and is related to the eye-weighted value of either reflectance or transmittance (also known as normalized Y Tristimulus value) by the Y Tristimulus value of a white reference, Yref: L*=116*(Y/Yref)−16. The a*-parameter is a color coordinate that denotes the color gamut ranging from red (positive a*) to green (negative a*), and b* is a color coordinate that denotes the color gamut ranging from yellow and blue (positive and negative values of b*, respectively). As used in this application, Y (sometimes also referred to as Cap Y), represents the overall reflectance weighted to the human eye's sensitivity to visible light. For example, absorption spectra of an electrochromic medium, as measured at any particular voltage applied to the medium, may be converted to a three-number designation corresponding to a set of L*a*b* values. To calculate a set of color coordinates, such as L*a*b* values, from the spectral transmission or reflectance, two additional parameters are required. One is the spectral power distribution of the source or illuminant. The present disclosure uses CIE Standard Illuminant A to simulate light from automobile headlamps and uses CIE Standard Illuminant D₆₅ to simulate daylight. The second parameter is the spectral response of the observer. Many of the examples below refer to a (reflectance) value Y from the 1964 CIE Standard since it corresponds more closely to the spectral reflectance than L*. The value of “color magnitude”, or C*, is defined as C*=\sqrt{(a*)²+(b*)²} and provides a measure for quantifying color neutrality. The metric of “color difference”, or ΔC* is defined as ΔC*=\sqrt{(a*−a*′)²+(b*−b*′)²}, where (a*,b*) and (a*′,b*′) describe color of light obtained in two different measurements. Additional CIELAB metric is defined as ΔE*=(Δa*²+Δb*²+ΔL*²)^{1/2}. The color values described herein are based, unless stated otherwise, on the CIE Standard D₆₅ illuminant and the 10-degree observer. An optical element such as a mirror is said to be relatively color neutral in reflected light if the corresponding C* value of the element is generally less than 20. Preferably, however, a color-neutral optical element is characterized by the C* value of less than 15, and more preferably of less than about 10.

Icons such as UI-related icons for use with a mirror element of a rearview assembly can be formed in a reflective coating (including chromium or silver, for example) disposed on one of the surfaces of the mirror element by, for example, appropriately removing a portion of such coating such as to create a textual or graphical indicia that is further illuminated with light from a source of light in the back of the assembly. Another approach to forming rearview assembly icons may include using an appliqué layer behind a transparent or transflective portion of the mirror element of the assembly. The appliqué layer may include a polymeric light-transmitting substrate layer having some graphics or text printed on it such as to form an opaque indicia that appears dark to a user viewing the assembly from its front when the appliqué layer is illuminated from behind the first surface of the mirror element. Optionally, the polymeric substrate may be appropriately colored if color-coding of the indicia is required. Alternatively, most of the polymeric substrate layer may be opaque while at least a portion of the graphics and/or text indicia portion of the layer may be light-transmitting and, optionally, colored or tinted. For example, the appliqué layer may be disposed behind the fourth surface of the mirror element in spatial cooperation with the transflective portion of the mirror element. In this case, the opaque portion of the appliqué layer should appropriately cover the rear surface of the mirror element to ensure that no unintended stray light passes through or bleeds through the mirror element towards the field of view at the front of the assembly. A source of light providing illumination of the indicia may include an LED, an OLED, an incandescent source, an electroluminescent source, a fluorescent source or another appropriately chosen source of light.

A skilled artisan will readily appreciate that formation of rearview assembly icons utilizing indicia in an opaque appliqué layer requires not only precision in dimensioning the graphics and/or text formed by cutting or stamping through the appliqué layer, but also includes a rather laborious process of spatial alignment between the appliqué layer (whether cut through or printed upon) and portion(s) of the mirror element to which the indicia in the appliqué layer should be aligned or articulated. Given typically rather small indicia features, errors in such alignment may be significant. Embodiments of the present invention offer solutions alleviating these problems. The embodiments stem from the realization that forming an opening in and through an opaque layer of appliqué that has been already applied to a carrying substrate (such as a lite of glass of a mirror element of the rearview assembly) is more precise and reduces the cost of manufacturing of an associated icon. Formation of an opening may be achieved with laser ablation thereby facilitating the reduction of size of the opening or size of the opaque portions, as compared with a conventionally-produced indicia. Small islands of appliqué are particularly difficult to align one with another unless the islands are created after the appliqué is applied to the substrate. (Other methods of material removal from the appliqué layer such as cutting with dies or blades are also considered herein.) The discussion of illustrative embodiments of the invention is preceded, below, by a discussion of an example of a rearview assembly.

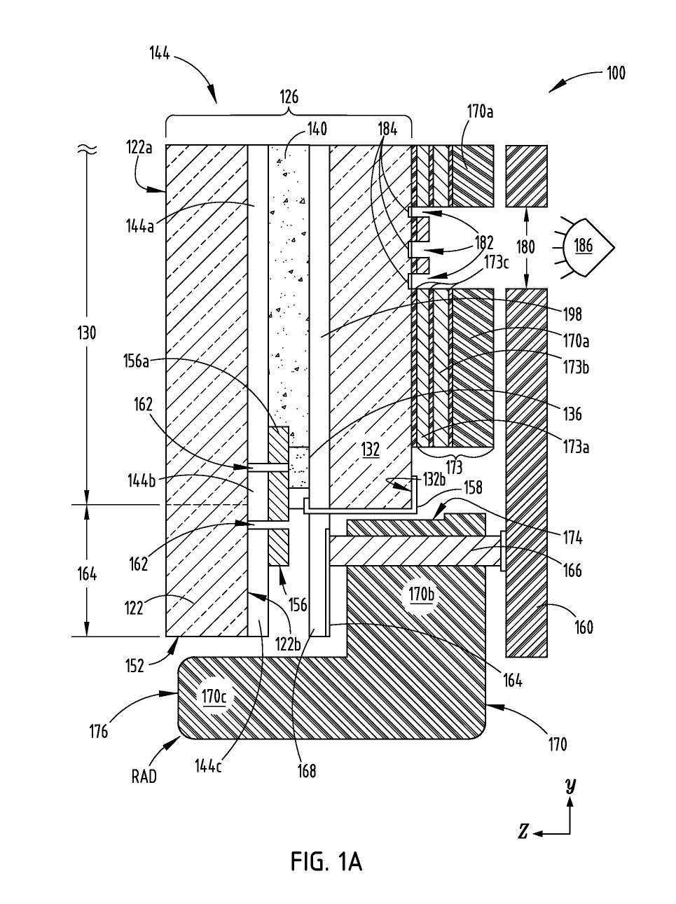

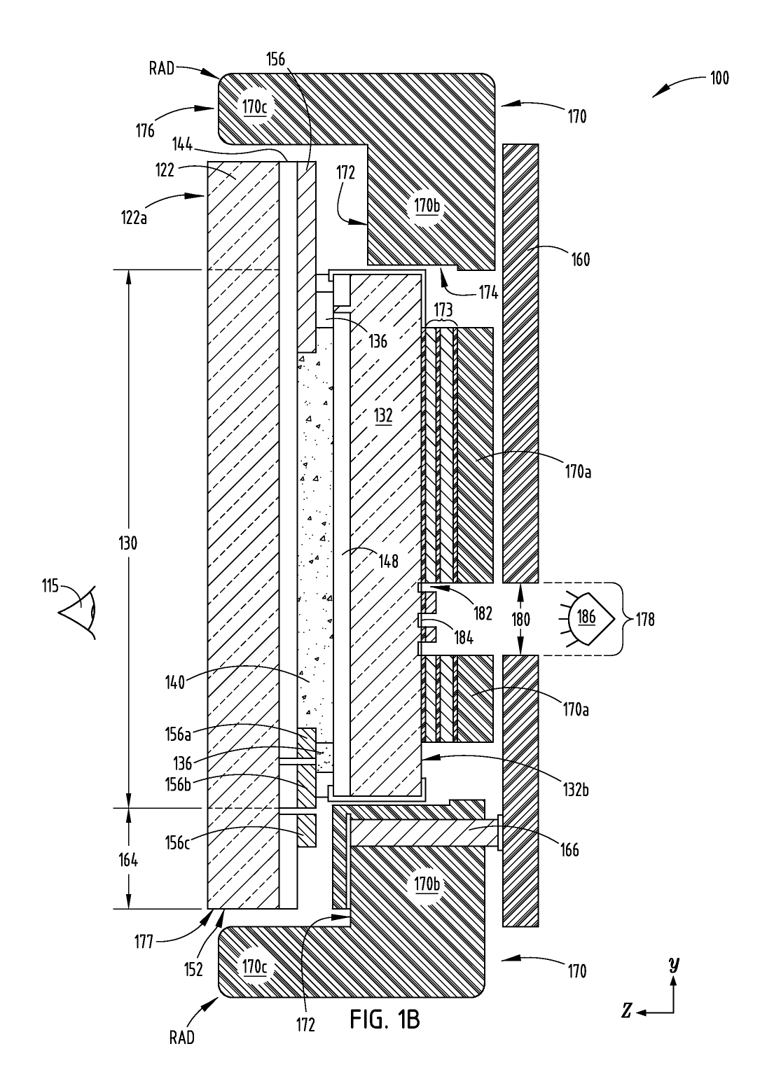

Referring now to the drawings, wherein like reference numerals indicate like parts throughout the drawings, FIGS. 1A, 1B provide schematic illustrations of a cross section of a portion of a rearview assembly containing an electrochromic (EC) element. FIG. 1A presents a part of the cross-sectional view of an embodiment 100, while FIG. 1B presents a complete cross-sectional view of the same embodiment 100. A user, observing the embodiment 100 from the front, is indicated with the numeral 115.

As shown, a first substrate or front element 122 of the EC element 126 supports the EC cell 130, which is generally defined by the first and second substrates (or elements) 122, 132 and a seal 136 disposed along and around the perimeter of the cell 130. The front or first surface of the first substrate 122 is denoted as 122a. The cell 130 contains an EC medium 140 in physical contact with a transparent electrically conductive layer 144 (such as a layer of transmissive conductive oxide or TCO) and a reflective thin-film stack 148. The second substrate 132 is shown to be positioned such that the perimeter of the second substrate 132 is not observable behind the first substrate 122 from the front of the embodiment 100.

In further reference to FIGS. 1A and 1B, when the electrically-conductive layer 144 is deposited across a second surface 122b of the EC element 126 and unless additional masking step is involved, the layer 144 is extended to the edge surface 152 of the first substrate 122. As shown, the electrically-conductive layer 144 is overcoated with a peripheral ring 156 of substantially opaque optical material disposed around the perimeter of the second surface 122b such as to conceal at least one of the seal 136 and a conductive member or connector 158 configured to establish electrical connection between at least one electrically-conductive layer of the EC-cell 126 through a conductive epoxy in contact with such layer and an electronic circuitry (not shown) on the PCB 160. The conductive member is shown to wrap-around an edge surface of the second substrate 132. In one embodiment, such conductive member 158 includes an electrically-conductive layer such as a thin-film layer, a foil, or a mesh, for example. In another embodiment, the member includes a clip.

As shown, in at least one portion of the embodiment 100 at least one electrical separation area 162 is established (by, for example, removing a strip of the combination of layers 144, 156 with laser ablation, or mechanically, or via chemical etching) to form electrically-separated electrically separated layer portions 144a, 144b, 144c cooperated with respectively corresponding layer portions 156a, 156b, 156c. A double-layer including layer portions 144c, 156c is shown to be spatially coordinated with a ledge formed by a portion of the first substrate 122 that transversely extends over the second substrate 132. It is appreciated that creating such electrically-separated layer portions facilitates formation of a switch element that is substantially electromagnetically (and, in particular, capacitively) decoupled from the EC cell 130 and that can be used as a switch of the UI of the embodiment 100. Such switch, including an electrically-conductive pad 164 connected with the PCB 160 through an electrically-conductive connect 166 that contains at least one of a specifically-designed metallic spring contact, a “zebra” strip, an electrically-conductive polymeric material or adhesive material, to name just a few. As shown, an embodiment of a switch also includes a graphic layer 168 juxtaposed with the conductive pad 164. The electrically-conductive portion 144c is characterized by a normal projection, onto the second surface 122b, that is adjacent to but does not have any contact with a normal projection of the portions 144a, 144b onto the same surface. As discussed in Our Prior Applications, the transparent conductive layer portion 144a is further provided with appropriate electrical connectors (not shown) to be operable as a transparent conductive electrode while the thin-film stack 148 is adapted to be operable as a reflective electrode of the EC cell 130. The peripheral ring 156 (made of chromium or other materials as taught in Our Prior Applications) is shown to be disposed on to of the layer 144. An alternative embodiment, not shown, may include a transparent conductive layer 144 disposed under the peripheral ring 156.

In further reference to FIGS. 1A, 1B, the EC element 126 of the embodiment 100 is supported, from the back, with a carrier 170, which is preferably made of a polymeric material and has an extended portion 170a positioned along a fourth surface of the EC element 126. The carrier 170 is appropriately shown to be shaped to establish a step portion 170b and a peripheral portion 170c. The step portion 170b integrally connects the extended portion 170a with the peripheral portion 170c (and, in one embodiment, all three portions of the carrier 170 are co-molded or molded as a unit) and defines two surfaces: a step surface 172, which is generally parallel to the second surface 122b, and a surface 174 that is generally transverse to the extended portion 170a. The extended portion 170a is affixed to and cooperated with the back (as shown, surface IV) of the EC-element via an bonding or appliqué layer 173 that includes, as shown, an opaque layer 173a and a foam layer 173b, interlaced with layers of adhesive material or bonding means 173c. The carrier 170 is appropriately dimensioned with respect to the size of the EC element 126 to have the peripheral portion 170c (i) accommodate the first substrate 122 on the inboard side of the peripheral portion 170c and (ii) accommodate the second substrate 132 on the inboard side of the surface 174. The peripheral portion 170c may be configured to be optically clear, optically diffusive (e.g., to have ground surface and, therefore, “frosted” appearance), or have a colored appearance. The peripheral portion 170c is additionally shaped such as to have its front surface 176 curved or smoothed, along the outer perimeter of the peripheral portion 170c, with a radius of curvature Rad of no less than 2.5 mm. The level to which the surface 176 is spatially protruding with respect to the first surface 122a of the EC element may generally lie above or below the glass surface 122a. While not shown in FIGS. 1A and 1B, a peripheral edge portion 177 of the first surface 122a of the embodiment 100 may also be Rad-rounded to reduce or eliminate the hard edge.

Referring, again, to FIGS. 1A, 1B, an icon 178 is implemented at a back surface 132b of the second substrate 132 of the EC-element 126 (i.e., at surface IV or the fourth surface) of the embodiment 100 within the bounds of an opening 180 formed through the PCB 160 and the extended portion 170a of the carrier 170. As shown, the icon 178 includes dimensionally-precise passages 182 ablated through the bonding layer 173 (or at least through a bonding-layer portion or bonding means that includes the two adhesive material layers 173c sandwiching the opaque layer 173a ) down to the surface 132b. In one implementation, optionally, the ablation of the icon 178 may include partial ablation of the back surface 132b of the EC element 126 as well, causing textured, optically translucent and/or optically diffusive patches 184 thereon. In practice, light incident through the opening 180 from a source of light 186 onto the icon 178 traverses the icon through the passages 182, through the optionally present textured patches 184 and further traverses the EC element towards the field of view at the front of the assembly 100, so that the icon 178 could be visually observed by the user 115 in backlighting. In one embodiment, a degree to which light traversing an optically-diffusive patch 184 is scattered is higher than a degree of light scattering provided by another portion of the substrate 132.

In one implementation, a black polyester appliqué having a thickness on the order of 0.1 mm (manufactured by 3M, Inc., for example) is applied to the back of a mirror element such as the mirror element 100 of FIGS. 1A, 1B. A CO₂ laser system (for example, Epilog Legend 36EXT), having an output of about 120 W at a wavelength of approximately 10 microns, is used to ablate the appliqué to create at least one opening therethrough and, optionally, to ablate a back surface of the mirror element (such as the fourth surface 132b of FIG. 1A) within the bounds of the ablated opening(s) such as to roughen the surface of the glass and to make it optically diffusive. The laser is set to the raster setting with 1200 dpi 50% power and 50% speed. A resulting icon contains ablated openings of dimensions varying between approximately several tens of microns to several millimeters (for example, between 70 microns and 10 mm) and with opaque portions separating these opening and/or “islands” of opaque material within a given opening, which vary in size within approximately the same range (between for example, 50 microns or 100 microns and a few millimeters). The typical rms roughness of the optionally-ablated glass surface is from about several tenths of a micron to several microns. It is appreciated that, during the ablation procedure, an optical system used to focus the laser-generated light onto the layer of the appliqué should be judiciously chosen to ensure than the Rayleigh range of the focused beam is optimized to prevent the ablation of the reflective thin-films stack on the third surface of the EC-cell of the mirror element (such as, for example, the thin-film stack 148 of FIGS. 1A, 1B). Absorption of laser light by the second substrate 132 facilitates protection of the interior coatings of the EC-element and the EC medium from laser-induced damage. Reduction of the laser-light intensity during the ablation procedure would also protect the EC-element from the unwanted damage.

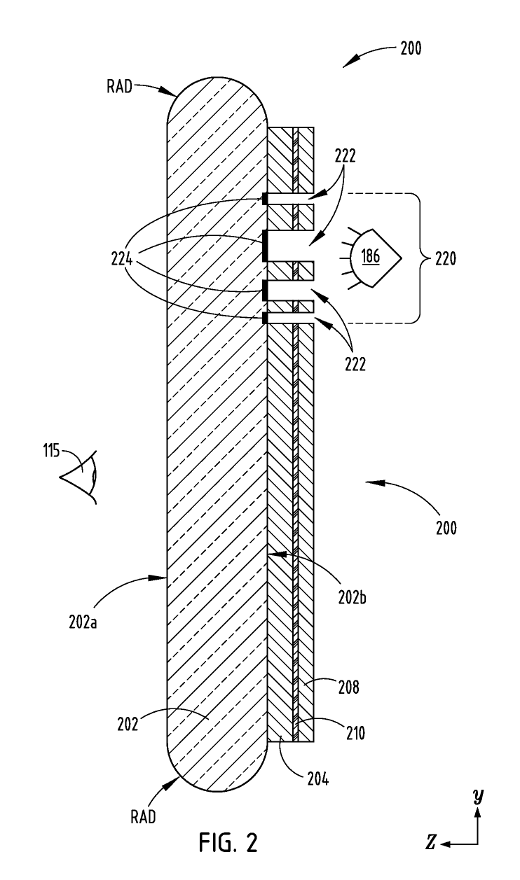

FIG. 2 is a cross-sectional view of a portion of a rearview assembly that includes a non-EC-based mirror element 200 (such as, for example, a prismatic element or another standard mirror element) having a substrate 202 with a first surface 202a and a second surface 202b. While no components mechanically supporting the mirror element 200 and no components of the housing assembly are shown in FIG. 2, such elements are implied. At least the peripheral edge of the first surface 202a is rounded with radius Rad of no less than 2.5 mm. A peripheral edge of the second surface 202b may be, optionally, beveled or inclined with respect to the surface 202b. As shown in FIG. 2, however, the peripheral edge of the second surface 202b is also rounded with the radius Rad. The at least partially reflective (and, optionally, transflective) coating 204 is carried on the surface 202b and is further covered with a film or layer 208 affixed to the coating 204 via an adhesive material layer or bonding means 210. In an embodiment where the coating 204 is transflective, the film 208 is preferably opaque to conceal the electrical connections, electronic circuitry and other components (not shown) of the assembly located at the back of the assembly behind the mirror element 200. An icon 220 is ablated through the film 208, the adhesive material layer or bonding means 210 and the reflective layer 204 down to the surface 202b, thereby forming ablated channels 222. In a specific embodiment, as shown in FIG. 2, the ablation of the icon 220 may include partial ablation of the surface 202b resulting in formation of textured, optically diffusive patches 224 of glass surface within the bounds of openings / passages ablated in the appliqué layer.

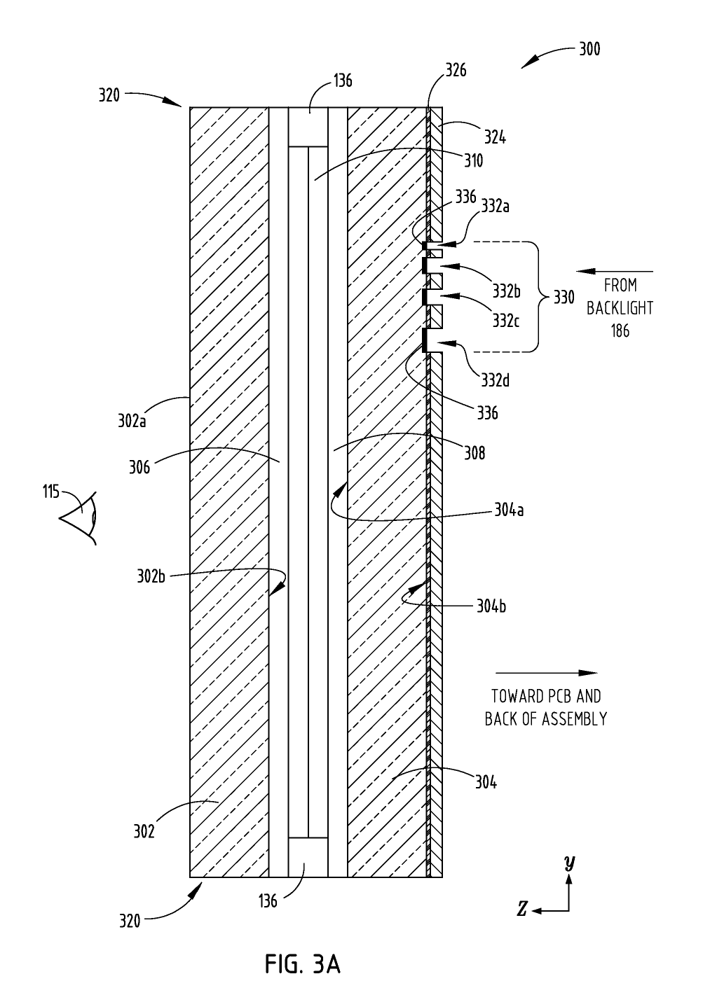

FIGS. 3A, 3B show, in cross-sectional views and in a simplified fashion, embodiments 300, 350 of transflective EC-based mirror elements for use with a rearview assembly of the present invention. The embodiment 300 includes first and second substrates 302, 304 that are disposed with no transverse offset with respect to one another and that are substantially aligned in a transverse direction (in xy-plane, as viewed by the user 115 from the front). In comparison, the embodiment 350 is shown with transverse offset(s) between the first and second substrates 302, 304 such as to form adapted to form ledges 354 that are appropriately configured for placement of electrically-conductive connectors establishing electrical communication between the PCB (not shown) at the back of the assembly and the EC-element. The first, second, third, and fourth surfaces of the embodiment 300 are denoted, respectively, as 302a, 302b, 304a, 304b. The transflective EC-elements of the embodiments 300, 350 are conventionally structured in that they have electrically-conductive coatings (generally, a TCO material, and in specific embodiments, ITO, AZO, for example) 306, 308 on surfaces 302b, 304a forming the EC-cell of the EC-element, and a transflective thin-film stack 310 carried on the third surface 304a. When the transflective layer 310 includes silver or silver-gold alloy, such layer is configured not to extend to the edge of the EC element but terminate inboard, approximately at the perimeter seal 136. Rear surfaces 304b of the embodiments 300, 350 carry an opaque film (appliqué) 324 affixed to a corresponding rear surface with an adhesive layer or bonding means 326. Various other coatings, including a peripheral ring, are not shown for simplicity of illustration and are implied.

While no peripheral ring is shown the second surface 302b of the embodiment, such peripheral ring is implied to conceal the perimeter seal 136 and the above-mentioned electrically-conductive connectors establishing electrical contacts with the EC-element electrodes 306, 308. While the embodiments 300, 350 are shown with a hard perimeter edge 320 of the first surface 302a, it is appreciated that in a related embodiment (not shown) this hard edge may be rounded to form a curvature with a radius Rad and, optionally, additionally grounded to form a roughened, optically diffusive and durable surface of the Rad-rounded edge, by analogy to the rounded front edge of the embodiment 200 of FIG. 2.

In each of the embodiments 300, 350 has an icon 330 configured, as described above in reference to FIGS. 1A, 1B, and 2, by ablating channels 332a, 332b, 332c, 332d through the applique layer and the layer of adhesive (or bonding means) down to the glass surface 304b. Optionally, the surface of the glass within the bounds of the channels 332a, 32b, 332c, 332d can be also ablated to form patches 336 of textured or roughened glass, which would be diffusing light from the light source 186 (not shown)at the back of the rearview assembly upon its propagation through the channels and the roughened patches of the icon 330 towards the viewer 115. The cross-sectional dimensions of the ablated channels of an icon such as the icons 178, 220, or 330 (of FIGS. 1A, 1B; 2; and 3A, 3B, respectively) are dictated by the graphical or textual information associated with the icon and are, therefore, generally different.

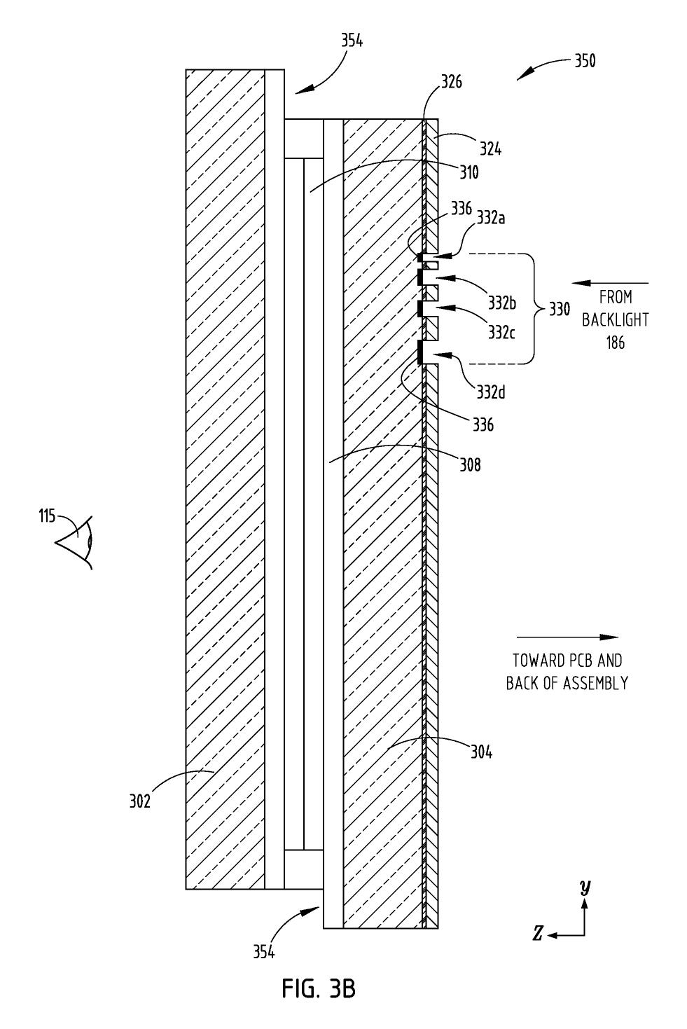

Considering an embodiment 400, related to the embodiment 100 of FIGS. 1A, 1B, a relevant portion of which is shown in FIG. 4, the carrier 170 may be devoid of the peripheral portion 170c and a perimeter edge of the front surface 122a of the front element 122 has, in turn, a curvature with a radius Rad and, optionally, a surface that is grounded or roughened in the area of such curvature. In the latter case, the corresponding portion of the grounded Rad-rounded peripheral edge of the first surface 122b is translucent and/or optically diffusive. As shown, the embodiment 400 contains two icon areas: an icon area 410 through which light from a back-light source 186 is transmitting through the EC-element 412 towards the field -of view at the front of the embodiment (towards the user 115) and an icon area 420 formed in cooperation with a ledge portion 422 of the first substrate 122 that extends over an edge surface 424 of the second substrate 132. The icon areas 410, 420 are configured as discussed above and include passage(s) 411a ablated in a corresponding applique layer (carried by either the fourth or the second surface 132b, 122b, respectively), “islands” and/or separating portions 411b, 421b of material inside and/or in between such passages that are not connected to the continuous portion 173a, 173b of the layer 173 and, optionally, ablated glass patches associated with and within the bounds of such ablated passages. Dimensions of the icon portions 411b for creation of which embodiments of the present invention are particularly beneficial over the related art are on the order of several tens of microns to several hundreds of microns, as the ablation technique facilitates the formation of such small feature in a repeatable and precise fashion. The icon area 420 is illuminated with light shown schematically with arrows 430 delivered from the back of the assembly.

At least one icon opening ablated in the opaque layer may be optionally painted or tinted (such as with a thin-film coating or colored ink) to create an area of an icon that is perceived as being colored. The ink may include a solvent based system, a UV curable system, a sublimation ink, a dye-based color system or a pigment based system. Alternatively, a second colored layer such as a layer 434 can be added to an area of the icon such as icon 410 to ensure that light transmitted from the back of the assembly through the icon towards the filed-of-view at the front of the assembly is colored. In a related embodiment, the layer 434 may be configured to include an optical diffuser.

Another related embodiment 500 of FIG. 5 shows a portion of the cross-sectional view of an EC-element based mirror of the rearview assembly similar to that of FIG. 4, but containing only one icon area 410 in the transflective portion of the EC-element and a switch arrangement in a portion of the second surface corresponding to the layer 144c. (An electrically-conductive portion 434a of the switch arrangement is configured as capacitive pads, and no connection between the pads 434a and the electronic circuitry at the back of the assembly is shown for simplicity of illustration). It is appreciated that both embodiments 400 and 500 (employing a cooperation between the first and second substrates 122, 132 in what is referred to as a “cut-out substrate design” in Our Prior Applications) are shown schematically, without indication of mechanical articulation between the carrier 170 and the EC-element 412, and without complicating the drawings with elements of the housing of the assembly.

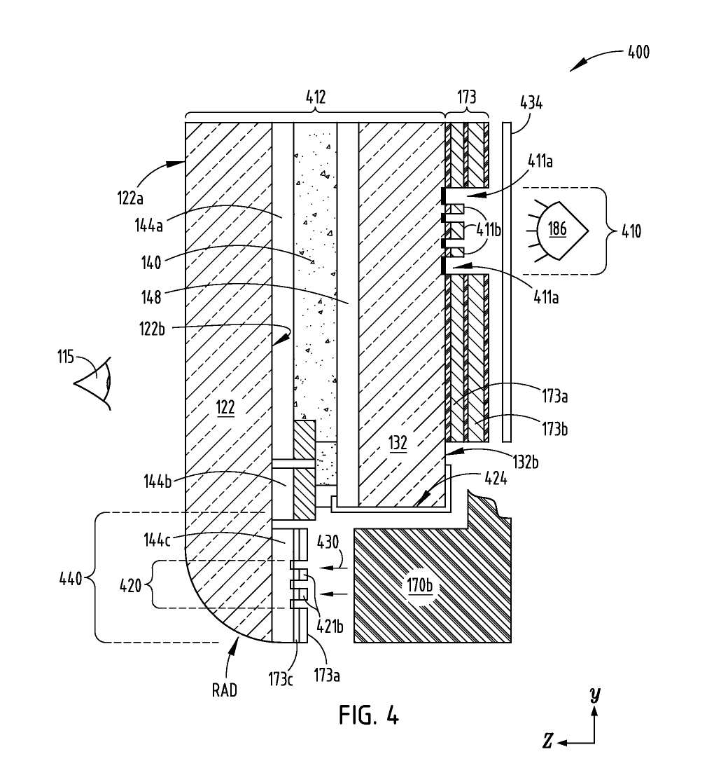

FIG. 6 is a generalized front view of an embodiment having a mirror element with a front substrate that contains an outer edge curved / rounded with a radius Rad such as, for example, the embodiment 400 of FIG. 4 or the embodiment 500 of FIG. 5. Here, designations FCN1, FCN2, FCN3 are used to indicate graphical and/or textual icon patterns (optionally having opening and island features as described above) that are indicative of particular functions and/or auxiliary devices of the rearview assembly configured to be activated via user input applied to the areas carrying these designations. An indictor 602 such as an indicator light may be optionally employed to show if a particular function and/or auxiliary device has been activated. The icon area(s) 410a, 410b, 410c are shown to include open areas corresponding to ablated passages/openings 411a and opaque “islands” of material 411b surrounded by openings 411a. Transflective areas of the embodiment corresponding to an auxiliary device such as a display at the back of the rearview assembly are now shown.

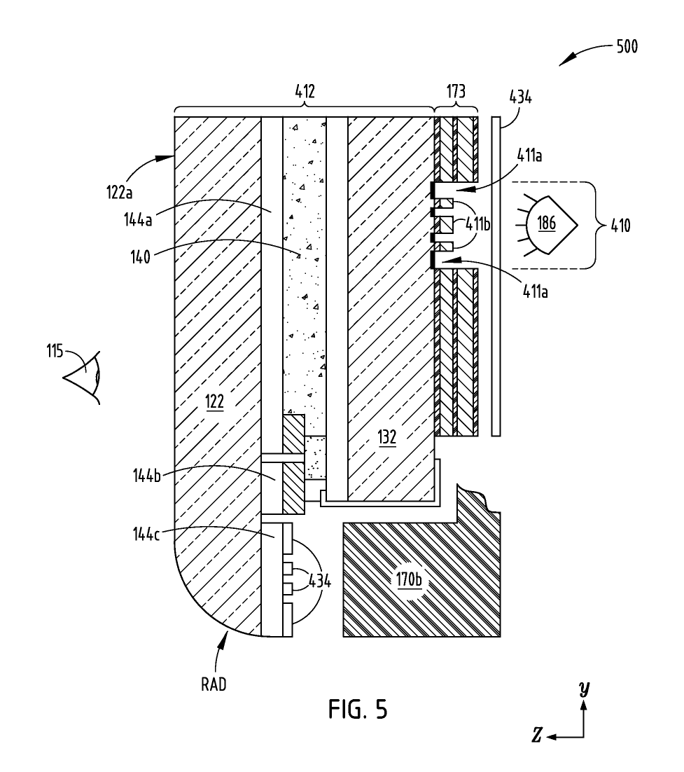

In another embodiment 700, shown schematically in FIG. 7, an icon 702 is formed, according to a method of the invention, in an appliqué layer 704 affixed to the fourth surface 706 of the EC-element 708 such as to ensure the spatial alignment of the icon 702 with a transflective zone 710 of an EC-element 708. The transflective zone 710 of the EC-element 708 is configured to include a dotted pattern provided in an otherwise opaque thin-film coating 712 on the third surface 714 (configured as a third-surface reflector of the EC-element 710). Such spatially-defined patterning, resulting in a useful level of transmission of an area of the opaque coating within pre-defined boundaries was described, for example, in a commonly assigned U.S. Patent Application Publication No. 2006/0007550 and is not discussed here in any detail. The icon 704 contains openings through the layer 704 down to the glass surface 706, remaining portions 718 of the layer 704 that are forming the graphical indicia within the boundaries of the icon 702 and, optionally, textured or roughened patches 720 of glass surface within the boundaries of the openings, as discussed above. Geometry and some of various components of the EC-element 708 are drawn with no regard to precision and scale, nor are the elements of the housing structure or electronic circuitry of the assembly shown for simplicity of illustration. All the components and auxiliary devices required for proper operation of the rearview assembly are implied, nevertheless.

In related embodiments of the invention, graphical and/or textual indicia are formed in coordination with a heater element of the assembly. Specifically, the metallic traces of either a conventional constant wattage (CW) heating element of a conventional positive thermal coefficient (PTC) heating element are configured to form the opaque areas of graphical and/or textual indicia of an icon.

Two types of heating elements are typically used in rearview mirror applications. CW heaters use an electrically-conductive material as a resistive heating component. The heating-element traces are continuous but may branch into two or more electrically conductive pathways. For automotive applications, where the potential applied to the terminals of the heating element is typically fixed, the resistance of the trace is the determining factor in the heater wattage. The potential, or a supply of electrical power to electrical terminals of the heater that are in electrical communication with a power supply, which can include the heater being in electrical communication with a vehicle power system (e.g., a vehicle battery). The PTC type heating element uses a material that has a positive thermal coefficient as the resistive portion of the heating element and provides traces with conductivity typically higher than that of the CW heater traces to distribute the current throughout the mirror. Since the resistance in the traces is low in comparison to the PTC material, the traces act as an electrical bus and little heat is generated in the traces themselves. The CW heaters may be manufactured, for example, by laminating a metallic foil to a heater substrate and then patterning and etching the metal to create heating element traces. The traces may also be generated by dispensing or screen printing a conductive paste or epoxy. Alternatively an electroless plating process can be used in combination with dispensing or printing. The PTC material used in a PTC heater is typically opaque and can also be used to provide an icon area. When the PTC material is printed or dispensed on the substrate, areas can be patterned to provide the icon graphics. The PTC material in the graphics area can be used to generate heat if the material is electrically connected to the heater traces.

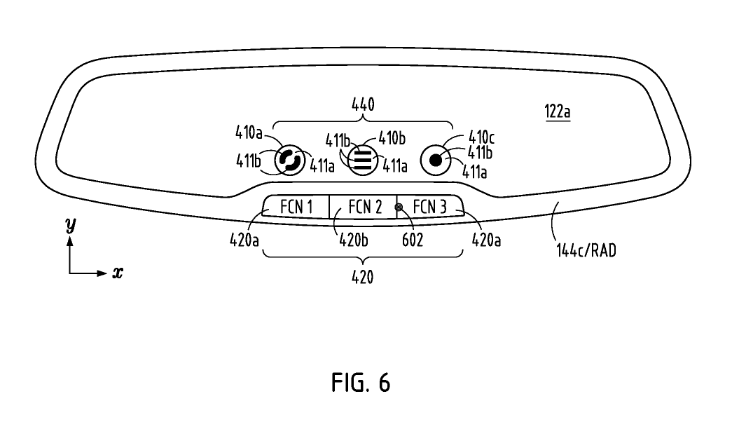

Heating elements of related art, such as CW or PTC heaters, for example, are disposed inside the rearview assembly behind and next to the rear surface of an automotive mirror element and a portion of the mounting structure supporting the mirror element (such as, for example, a mirror element carrier) and, therefore, in front of auxiliary devices such as a display, a turn signal indicator, a keyhole illuminator, a puddle light, a photosensor or other devices. To optimize the operation of such a rearview assembly, a heating element is configured not to obstruct areas of a rearview assembly that are corresponding to the sources of light transmitting light from the back of the assembly towards the field of view at the front of the assembly. For example, as shown in FIG. 8, an embodiment 800 of a multi-zone heating element described in a commonly assigned U.S. patent application Ser. No. 12/686,019 has a cut-out portion 810 in an area corresponding to a turning signal, a blind-spot indicator, a back-lit icon, or any other light indicia. In a rearview assembly, the opening 810 is arranged in overlying registry with the predetermined area of the mirror element through which the light is transmitted. For example, in an automotive rearview assembly including an EC-mirror element and an information display behind the EC-element (see Our Prior Applications), the position of the light indicia opening in the heating pattern may be defined by the position of the display across the mirror element. A consequence of having such trace-free area in a heating element is that a corresponding portion of the mirror element is not cooperated with a heater and is not heated up, thereby increasing the defrost time and creating unwanted thermal gradients across the mirror surface. This problem is exacerbated if an area corresponding to the icon is large. Tracings of the heating element are typically several tenths of a millimeter to about a millimeter apart, and the area density of the heating traces is a factor determining the uniformity and the power density delivered to the mirror element (usually measured in W/cm^{2).}

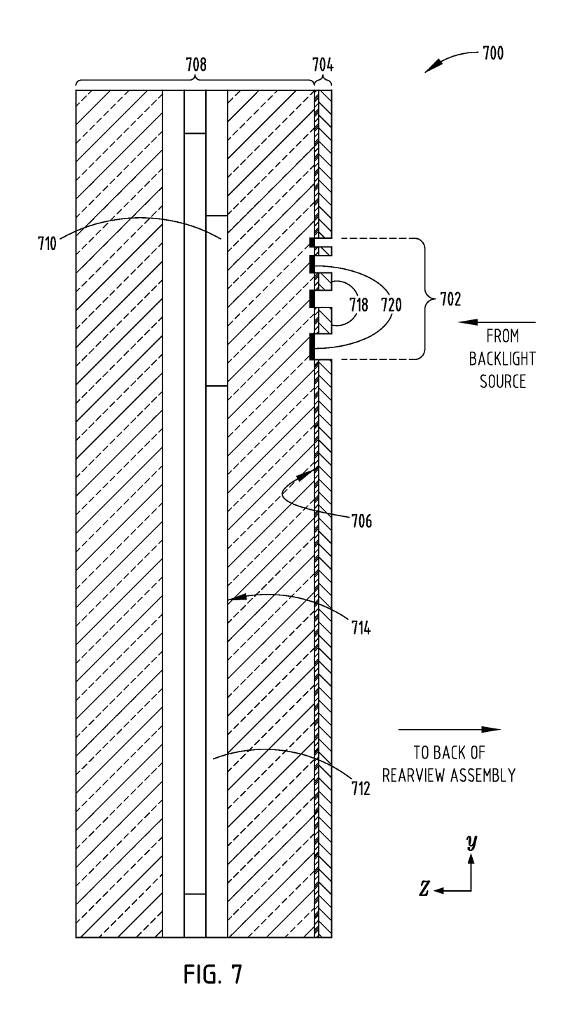

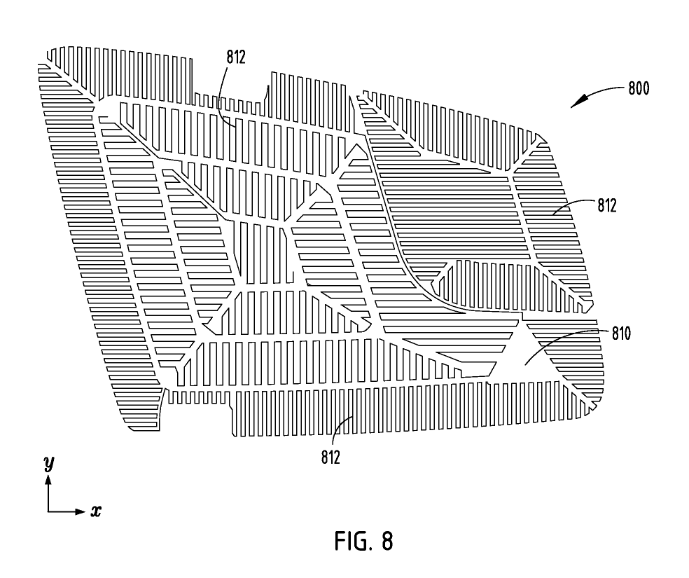

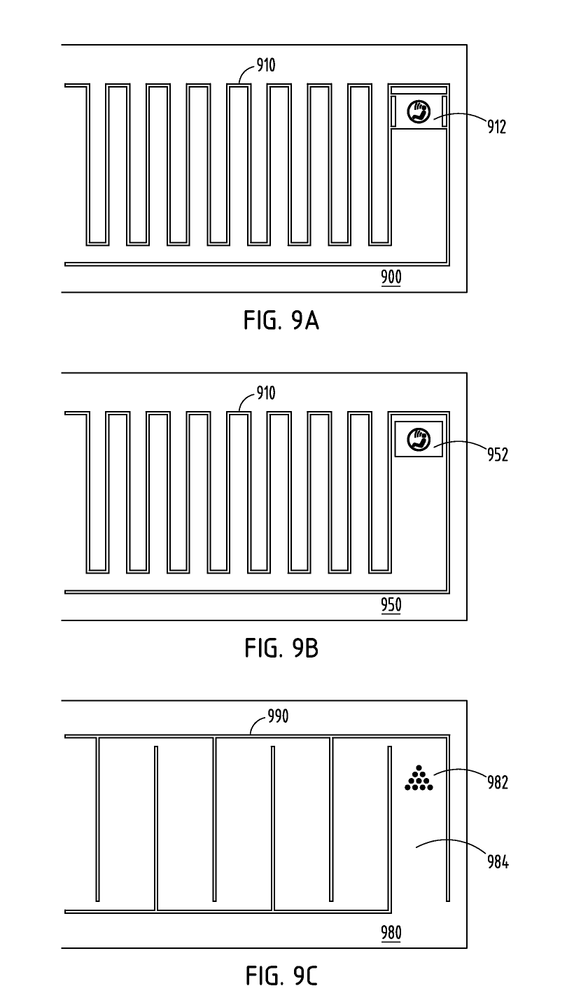

According to one embodiment of the invention, a trace of the heating element is configured or patterned to include a portion representing indicia required for a given icon associated with the rearview assembly. An example of a heating element 900 having such a trace 910 is schematically shown in FIG. 9A. Here, the trace 910 is configured to include an “indicia” portion 912 appropriately structured to present the required visual information (as shown, an indication of a voice-activated system) and electrically-connected to the remaining portion of the trace 910. In practice, and in further reference to FIG. 8, the indicia portion 912 of the embodiment 900 would be coordinated in place of the opening 812 of the heating element of FIG. 8. A skilled artisan will readily appreciate that this embodiment of the icon indicia allows for using a spatially uninterrupted heating element devoid of cut-out portions that are configured to be aligned with a light source of the rearview assembly and, in addition, for heating a portion of the mirror element associated with a corresponding icon. An alternative embodiment 950, where an indicia 952 of an icon is configured from a material used to create the heating-element trace 910 but is electrically decoupled from the trace 910, is shown in FIG. 9B. The heating element trace material 910 of the indicia 952 would not be heated directly, although the thermal conduction properties of the trace material will provide some benefit in conduction heat from the heating element trace to the icon area. Another alternate embodiment is shown in FIG. 9C, where heater 980 comprises an indicia 982 of an icon which is configured by printing holes in the PTC material 984. Highly conductive material 990 is used as the electrical bus material. Since current will flow through the icon area, heat will be generated in in the icon area. The distance between the two bus materials may be reduced in the icon area to account for the loss of conductivity resulting from the voids in the PTC material.

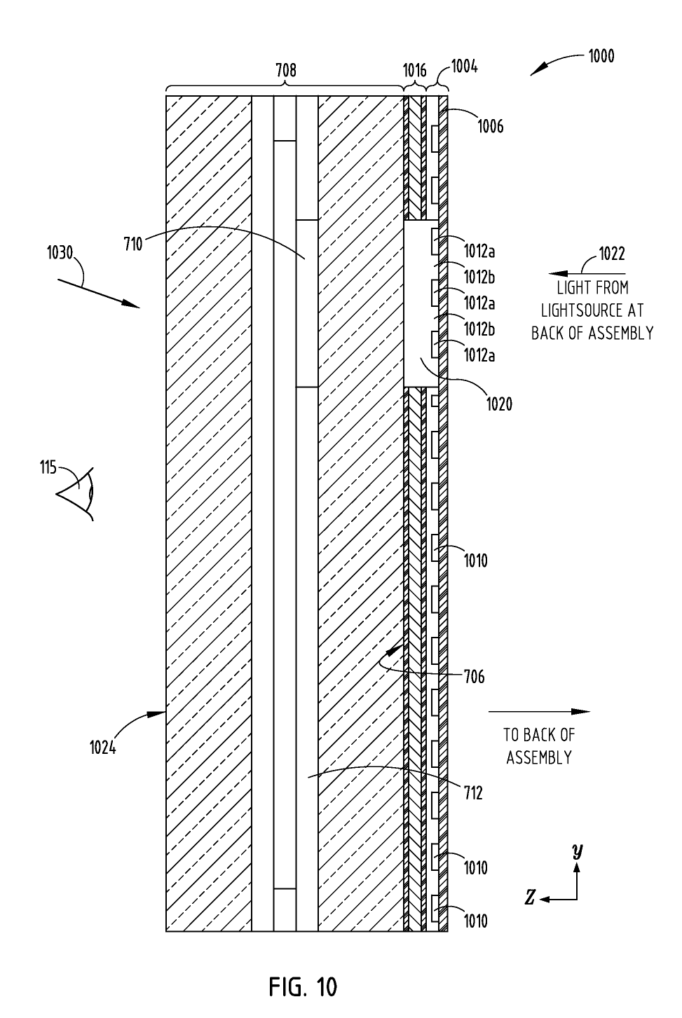

FIG. 10 shows a simplified cross-sectional view 1000 of an EC-element based mirror (of a rearview assembly) such as the EC-element 708 of FIG. 7 cooperated with an embodiment 1004 of a heating element of the invention. As shown, the heating element 1004 including a heating element substrate 1006 and heating trace(s) 1010 disposed on it. A portion 1012a of the trace(s) and the spaces 1012b between the traces 1012a are configured to form a required indicator, by analogy with the portion 912 of FIG. 9A. The heating element 1004 is affixed to the fourth surface 706 of the EC-element 708 with an appropriate adhesion layer 1016 having a cut-out portion (an opening through the adhesion layer) 1020. The opening 1020 in the adhesion layer normally forms a gap filled with air. When the indicia portion 1012a, 1012b of the heating element 1004 is highlighted with light from the light source at the back of the rearview assembly (as shown with an arrow 1022), the indicia 1012a, 1012b is observable from the front of the assembly (corresponding to the first substrate 1024 of the EC-element 708 and the viewer 115) through the transflective region 710 of the mirror element formed by a patterned portion of the opaque thin-film stack 712. While the heating element 1004 is shown in FIG. 10 to be attached to the EC-element 708, in a related embodiment (not shown) the heater element may be spatially separated from the EC-element by a gap (of air, for example). In another alternative embodiment (not shown) the heater element 1004 may be affixed to the back of the EC element through an adhesive layer (bonding means) 1016 that does not have a cut-out portion such as the portion 1020 through which the indicia 1012a, 1012b can be viewed from the front of the assembly. In this case, to ensure the visibility of the indicia, the adhesive layer or bonding means should be relatively transparent and, optionally, colorless.

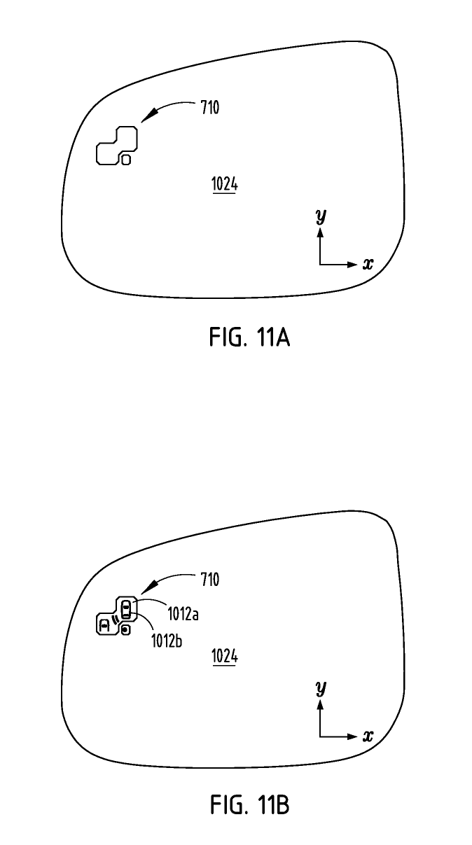

In further reference to FIG. 10, FIGS. 11A and 11B show schematically a plan view of the embodiment 1000, where the transflective zone 710 corresponds to a blind-spot indicator of the rearview assembly. As shown in FIG. 11A, when the blind-spot activator is off (no light 1022 is incident onto the indicia 1012a, 1012b from the light source at the back of the assembly), no indicia is observable from the front of the assembly in the transflective zone 710. When the corresponding sensor and the associated electronic circuitry recognize the presence of another vehicle in the blind spot, light 1022 is activated and the indicia (as shown, contours of the vehicles) are observed in light transmitted through the passages 1012b between the traces 1012a of the heating element 1004.

Referring again to FIGS. 7, 10, 11A, 11B because the heating trace portion 1012a is visible from the front of the assembly through the transflective zone 710, it is beneficial to ensure that the reflectance and color characteristics of the trace portion 1012a observed in ambient light 1030 incident onto the first surface 1024 of the embodiment 1000 (such as, for example, light incident from a D65 standard illuminant known in the art) are sufficiently well matched to those of the third surface reflector 712. For example, if the third surface reflector 712 has a generally neutral color characteristic in reflection (defined, for the purposes of this application, as light having a CIELAB metric C* that is generally less than about 20), the material of heating trace(s) may be chosen to have a substantially similar C* value in reflection. In one embodiment, for example, the use of an aluminum trace in a heating element may be preferred over the use of the copper trace because aluminum has a more even spectral reflectance characteristic across the visible portion of the spectrum. In addition or alternatively, the metallic trace can be formed of a mix of metals with an overcoat of an aluminum film.

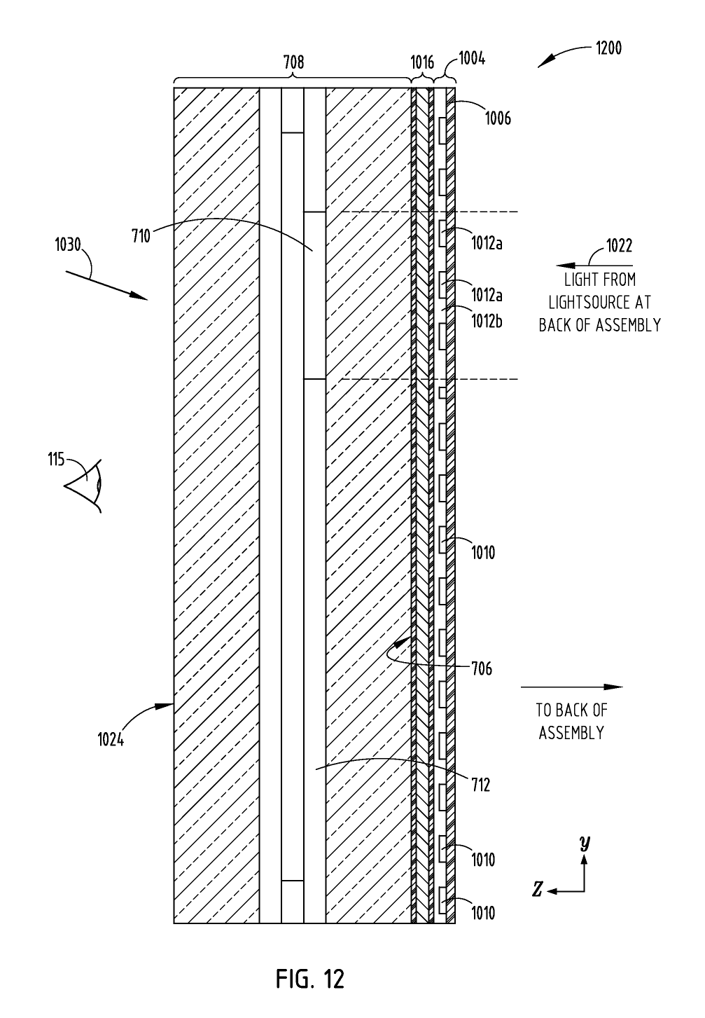

FIG. 12 shows, in a cross-sectional view, a portion 1200 of the rearview assembly corresponding to the embodiment 1000 of FIG. 10. However, in comparison with the embodiment 1000, in the embodiment 1200 the heating element 1004 is affixed to the fourth surface 706 of the EC-element 708 through a continuous adhesive layer 1216. In further reference to FIGS. 10 and 12, Table 1 summarizes the examples of results of calculation of reflectance values for the portion 1012a of the heating element 1004 (which is observable through the transflective zone 710 of the EC-element 708) in light incident onto the front surface of the embodiment and further to the portion 1012a through the transflective zone 710. The several non-limiting examples correspond to different metallic materials (metals and/or alloys of metals) that are used to form the heating element traces 1012a, both for the embodiment 1000 and the embodiment 1200. It is appreciated that the results of this calculation include the situation when the heating element traces are overcoated with a metallic layer. The row of Table titled “Reference (Std Element)” provides reference values for reflectance (Y) and several CIELAB characteristics (a*, b*, L*) of a conventionally used EC-element having a typical third-surface reflector. The heating element 1004 is approximated by a thin-film of metallic material listed in Table 1 and disposed onto the substrate 1006 of the heating element. In case of the embodiment 1000, the incident medium for such thin-film calculations is air, while in the case of embodiment 1200 such incident medium is the (now transparent) adhesive layer 1216 with refractive index of about 1.51.

TABLE 1

| | Embodiment 1200 ( no air gap) | | | | Embodiment 1000 (air gap) | | | |
|---|---|---|---|---|---|---|---|---|
| Coating Type | Y | L* | a* | b* | Y | L* | a* | b* |
| Reference (Std Element) | 54.8 | 78.9 | −2.5 | 0.9 | 54.8 | 78.9 | −2.5 | 0.9 |
| chrome | 48.9 | 75.4 | −3.3 | −1.1 | 59.7 | 81.7 | −3.3 | 0.5 |
| Ru | 52.4 | 77.5 | −3.1 | 1.0 | 65.5 | 84.7 | −2.7 | 1.7 |
| silver gold 7× | 79.2 | 91.3 | −3.1 | 3.4 | 85.5 | 94.1 | −3.2 | 3.1 |
| aluminum | 78.3 | 90.9 | −3.4 | 1.0 | 81.5 | 92.4 | −3.4 | 1.4 |
| Al:Si 60:40 | 50.3 | 76.3 | −2.1 | 1.1 | 60.6 | 82.2 | −2.5 | 1.7 |
| Al:Si 80:20 | 61.2 | 82.5 | −2.6 | 3.2 | 68.7 | 86.4 | −2.8 | 3.2 |
| W | 44.3 | 72.4 | −1.0 | 2.6 | 55.8 | 79.5 | −1.7 | 2.8 |
| Al:Si 90:10 | 68.2 | 86.1 | −3.0 | 2.7 | 74.1 | 89.0 | −3.1 | 2.7 |
| Al:Ti 50:50 | 38.1 | 68.1 | −0.7 | 3.0 | 49.8 | 76.0 | −1.5 | 3.4 |
| Al:Ti 70:30 | 41.8 | 70.8 | −0.9 | 2.4 | 53.4 | 78.1 | −1.6 | 2.8 |
| Al:Cu | 77.5 | 90.6 | −3.4 | 1.3 | 80.9 | 92.1 | −3.4 | 1.7 |
| Cd | 65.0 | 84.5 | −3.3 | 0.4 | 71.4 | 87.7 | −3.3 | 1.3 |
| Cobalt | 49.9 | 76.0 | −1.4 | 4.1 | 59.7 | 81.7 | −2.0 | 4.0 |
| Cu | 55.2 | 79.1 | 12.2 | 14.3 | 62.2 | 83.0 | 8.2 | 11.6 |
| brass (Cu:Zn) | 62.4 | 83.1 | −1.0 | 22.2 | 68.1 | 86.1 | −1.7 | 18.7 |
| Ge | 38.2 | 68.2 | 3.8 | 4.6 | 49.5 | 75.8 | 1.3 | 3.5 |
| Mo | 43.3 | 71.8 | −3.2 | 1.6 | 55.0 | 79.0 | −3.3 | 2.1 |
| Pd | 54.3 | 78.7 | −1.3 | 4.7 | 63.1 | 83.5 | −1.9 | 4.4 |
| Pt | 48.1 | 74.9 | −1.1 | 5.1 | 58.3 | 80.9 | −1.8 | 4.8 |
| Re | 42.3 | 71.1 | −2.6 | 0.9 | 54.2 | 78.6 | −2.7 | 1.6 |
| Rh | 56.6 | 79.9 | −1.3 | 3.2 | 65.3 | 84.6 | −1.9 | 3.1 |
| Si | 53.0 | 77.9 | −2.5 | 7.6 | 59.8 | 81.7 | −3.2 | 4.9 |
| Ta | 42.6 | 71.3 | −1.1 | 3.3 | 54.3 | 78.6 | −1.9 | 3.4 |
| Ti | 36.4 | 66.8 | 0.3 | 4.0 | 47.5 | 74.5 | −0.6 | 4.6 |
| V | 40.1 | 69.5 | −2.3 | −1.6 | 52.2 | 77.4 | −2.5 | −0.2 |
| Zn | 64.7 | 84.3 | −10.2 | −3.1 | 71.2 | 87.6 | −8.1 | −1.2 |

The net optical effect (color and reflectance values) perceived in reflection of light 1030 by the viewer 115 from the front of the assembly is approximately the average of effects produced by the third surface mirror reflector and the heating element reflector 1010, 1012a appropriately adjusted for the net area of each reflector. The size of the holes or openings in the patterned portion 710 of the reflecting stack 712 and the distance between the viewer 115 and the third surface mirror reflector affect the perceived color. According to the embodiments of the invention, the heating element is configured to include trace(s) made of the material providing for reflectance of at least approximately 50 percent; preferably of at least approximately 60 percent; more preferably of at least approximately 65 percent; and even more preferably of greater than about 75 percent. According to the embodiments of the present invention, a first reflectance value (measured in incident light from the standard D65 illuminant reflected, through the transflective patterned zone 710 of a conventionally configured EC-mirror element, off of the heating-element traces corresponding to such transflective zone) differs from a second reflectance value (measured in the same incident light reflected off of the area of the mirror that corresponds to the continuous portion of the third-surface reflector) by no more than 20 percentage points; more preferably by no more than 15 percentage points; even more preferably by no more than 10 percentage points; and even more preferably by no more than 5 percentage points. In addition or alternatively, color characteristics of incident light portions thus reflected differ by no more than 30 C* units; more preferably by no more than 20 C* units; more preferably by no more than 8 C* units; even more preferably by no more than 6 C* units, and most preferably by no more than 3 C* units.

It is appreciated that, in alternative embodiments, it may be preferred not to match the color and/or reflectance of the heating-element-based indicia with those of the major portion 712 of the third-surface mirror reflector but, instead, to achieve a pre-determined difference in color and/or reflectance characteristics of these elements. The desired color/reflectance (mis)matching is achievable with the use of methods disclosed in our Prior Applications.

In further reference to embodiments of FIGS. 10, 11A, 11B, 12, the dimensions of the holes forming the pattern in the transflective portion 710 of the third-surface reflector are a factor that affects the appearance of the mirror in the area 710. In some cases, the patterning may be created by laser deletion of portions of the continuous reflecting stack on the third surface. Such deletion may leave debris or un-ablated material within the bounds of the pattern or may form oxidized materials. In this case the heating-element reflecting traces 1012a (or, alternatively, the traces 1012a overcoated with an—optionally metallic—reflecting layer) have to be judiciously adapted to compensate for such manufacturing artifact. In this case empirical experimentation may be needed to achieve the desired match or aesthetic in the patterned area 710 in the mirror reflector.

Although the foregoing discussion has been mostly presented with respect to an electro-optic (EO) element such as the EC, it will be understood that the use of any element—whether an electro-optic or a simple prismatic element—is contemplated in conjunction with embodiments of the present invention.

While specific values and parameters are recited for various exemplary embodiments, described with reference to drawings herein, it is to be understood that, within the scope of the invention, the values of all of parameters may vary over wide ranges to suit different applications and that various modification are contemplated within the scope of the invention. Furthermore, disclosed aspects, or portions of these aspects, may be combined in ways not listed above. Accordingly, the invention should not be viewed as being limited to the disclosed embodiments, and appropriate modifications within the scope of the invention are also contemplated.

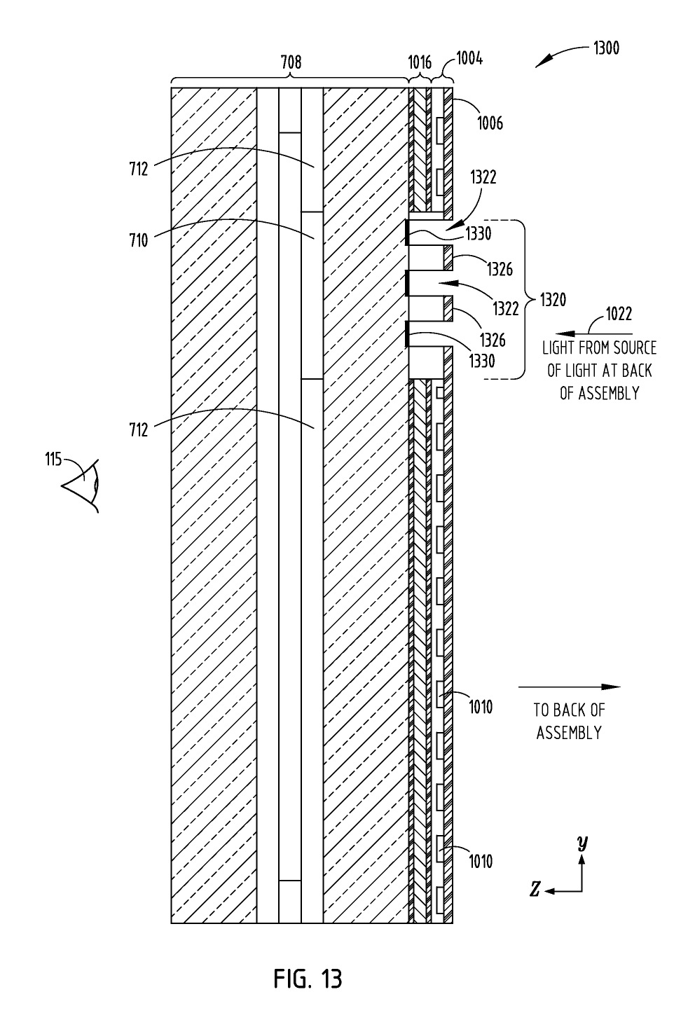

One of the possible modifications is shown in FIG. 13 that provides a cross-sectional view of an embodiment 1300, for use with a vehicular rearview assembly, that illustrates an icon portion 1320 formed by ablation of a corresponding graphical and/or textual indicia through the heating element 1004 and the adhesive or bonding layer 1016 to form openings 1322, through which the light 1022 transmits from the light source at the back of the assembly towards the front of the assembly and the user 115. The creating of the icon 1320 also forms portions 1326 (optionally including “island” portions within the bounds of a given opening 1326) that separate the openings 1322. Optionally, the icon 1320 includes at least one patch 1330 of textured glass surface, as discussed above.

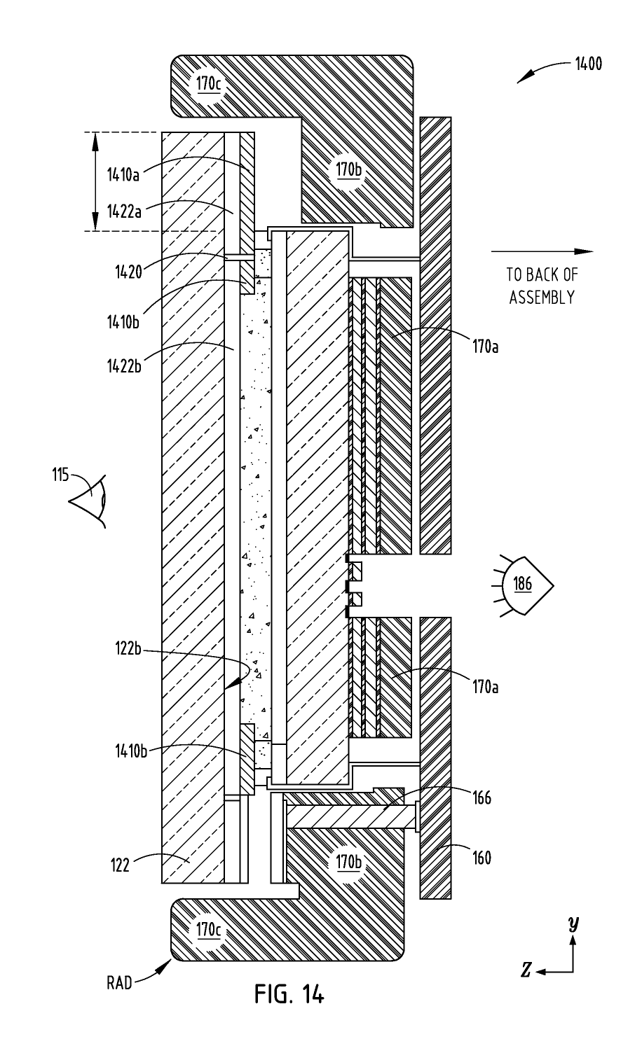

Another modification is shown in an embodiment 1400 of FIG. 14, which is similar to that of FIGS. 1A, 1B but contains differently configured electrically-conductive portion 1410a in relation to a peripheral ring 1410b, which necessitates an electrical separation area 1420 to be formed through the electrically-conductive layers carried on the second surface 122b such as to form substantially electrically separated stacks 1422a, 1410a and 1422b, 1410b.

According to one embodiment, ablation of a material, as described herein, can be ablation of a heater material (e.g., PTC material). For purposes of explanation and not limitation, with respect to FIG. 9C, this figure can illustrate ablation of PTC material and texturing the glass substrate.

Claims describing the embodiments of the invention are envisioned to include (but not be limited to) claims directed to (i) a heating element, for use with a mirror element of a rearview assembly, that includes an electrically conducting heating trace having a portion configured to represent graphical and/or textual indicia associated with at least one device of the rearview assembly, observable from the front of the assembly, and optionally having pre-determined spectral characteristics; (ii) a mirror element, for use with a rearview assembly, having indicia that is associated with at least one device of the assembly, is observable from the front of the assembly, and is ablated in a layer carried on a surface of the mirror element; (iii) indicia laser-ablated in a layer associated with a mirror element of the rearview assembly and configured to include feature(s) dimensioned according to pre-determined sizes; (iv) a rearview assembly including at least one of the abovementioned heating and mirror elements; and (v) a method for manufacturing at least one of abovementioned indicia, mirror element, heating element, and rearview assembly. Non-limiting tentative examples of envisioned claims are set below.

What is claimed is:

1. A heating element for use with a mirror element, the heating element comprising
a heating-element substrate;
electrical terminals on said substrate configured to receive electrical power from a power source; and
at least one heating zone defined by an electrically-conductive trace disposed on said spatially-continuous heating-element substrate in electrical connection with said electrical terminals, wherein an indicia portion of at least one heating zone includes a diagram represented by said electrically-conductive trace.

2. A mirror element comprising a front surface, a back surface, and a reflective layer having a zone substantially transmitting light, and further including a heating element according to claim 1 configured in optical communication with the back surface to make the indicia portion observable from the front surface through the zone substantially transmitting light.

3. The mirror element according to claim 2, wherein the heating element is separated from the back surface by an air gap.

4. The mirror element according to claim 2 and comprising an electrochromic (EC) element.

5. The mirror element according to claim 2, wherein said reflective layer comprises a transflective zone.

6. The heating element of claim 1, wherein at least a portion of said diagram is in electrical communication with said power source, such that at least a portion of said diagram is configured to generate heat.

7. The heating element of claim 1 further configured such that light from a light source propagates through at least a portion of said heating-element substrate that is substantially void of said electrically-conductive traces.

8. The heating element of claim 1, wherein said diagram is formed by laminating a metallic foil to a heater substrate and etching said metallic foil to form said electrically-conductive traces.

9. The heating element of claim 1, wherein said diagram is formed by dispensing one of a conductive paste or conductive epoxy.

10. The heating element of claim 1 being one of a constant wattage (CW) heater and a positive thermal coefficient (PTC) heater.

11. A vehicular rearview mirror assembly comprising
an electrochromic (EC) element comprising:
a first glass element having a front surface and a back surface;
a second glass element having a front surface and a back surface;
a reflective coating having a transflective zone on a surface internal to the EC element; and
a substantially opaque layer affixed to the back surface of the EC element, said substantially opaque layer having at least one opening therethrough defined by an opening boundary; and
at least one heating zone defined by an electrically-conductive trace disposed on said spatially-continuous heating-element substrate in electrical connection with said electrical terminals, wherein an indicia portion of at least one heating zone includes a diagram represented by said electrically-conductive trace.

12. The vehicular rearview mirror assembly of claim 11, wherein at least a portion of said diagram is in electrical communication with said power source, such that at least a portion of said diagram is configured to generate heat.

13. The vehicular rearview mirror assembly of claim 11 further configured such that light from a light source propagates through at least a portion of said heating-element substrate that is substantially void of said electrically-conductive traces.

14. The vehicular rearview mirror assembly of claim 11, wherein said diagram is formed by laminating a metallic foil to a heater substrate and etching said metallic foil to form said electrically-conductive traces.

15. The vehicular rearview mirror assembly of claim 11, wherein said diagram is formed by dispensing one of a conductive paste or conductive epoxy.

16. The vehicular rearview mirror assembly according to claim 11, wherein the heating element is separated from the back surface by an air gap.

17. The vehicular rearview mirror assembly of claim 11, wherein said heating element is one of a constant wattage (CW) heater and a positive thermal coefficient (PTC) heater.

18. A vehicular rearview mirror assembly comprising
a rearview mirror element comprising:
a reflective coating having a transflective zone on a surface internal to the EC element; and
a substantially opaque layer affixed to the back surface of the EC element, said substantially opaque layer having at least one laser ablated opening therethrough defined by an opening boundary;
wherein a back surface of the rearview mirror element within the bounds of said laser ablated opening is roughed.

19. The vehicular rearview mirror assembly of claim 18, wherein said substantially opaque layer is one of an appliqué and a heater.

20. The vehicular rearview mirror assembly according to claim 18, wherein said rearview mirror element is an electrochromic rear view mirror element.
